(19) United States
(12) Patent Application Publication
(10) Pub. No.: US 2008/0267169 A1
(43) Pub. Date: Oct. 30, 2008

(54) Method and system for remote diagnosis of a device over a communication network

(75) Inventors: Satish Kumar M. Mundra, Germantown, MD (US); David A. Lide, Rockville, MD (US); Sirish Bajpai, Gold River, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/790,507

(22) Filed: Apr. 26, 2007

(51) Int. Cl. H04L 12/66

(52) U.S. Cl. 370/352

(57) ABSTRACT

A device in a voice over packet (VOP) network includes a transceiver operable to transmit and receive session initiation protocol (SIP) communications over at least a portion of a VOP network. Also included is a processor cooperatively operable with the transceiver. The processor is configured to facilitate, responsive to receipt of an invite request, determining if the invite request is a diagnostic invite. If the invite request is a diagnostic invite, then the audible alert and display of caller id are suppressed. The processor is configured to generate a final response to establish two-way media flow and a dialog. After the dialog is established, diagnostics is launched on the device, and responsive to receipt of diagnostic information requests and after two-way media flow is established, the device responds with diagnostic information responses.

### TECHNICAL FIELD

The technical field relates in general to communication networks, and more specifically to enabling and/or conducting remote diagnosis of a device over the network.

### BACKGROUND

Voice over Internet protocol (VoIP) service providers are increasingly being burdened with the need for a well-staffed customer care center, which adds a fixed cost to operations. This cost seems to be increasing in line with subscriber growth. There is no end in sight to this growth as statistically a certain percentage of subscribers call up support for one reason or another.

Unlike a telephone in a traditional PSTN (public switched telephone network), in VoIP networks a VoIP CPE (customer premise/provided equipment) can be a fairly complex system. It is not unusual to find CPEs integrating multiple other functions such as WLAN (wireless local area network), LAN (local area network) switch, NAT/FW (network address translation/firewall), and more. In addition, there may be different devices that interface on home networks, for example ISP (Internet service provider) access technologies and available QOS (quality of service), home wiring, and the like, which add to this complexity but offer no clear distinction and make isolation of problems difficult.

This has resulted in significant costs which are incurred in supporting customers. Many problems may be unrelated to CPE behavior or voice service as such, and can still result in a customer care call. Even if the need for the support call is not altogether eliminated, the shortening of the call with more certain resolution or elimination of the problem is highly desirable.

### SUMMARY

Accordingly, one or more embodiments provide a device in a voice over packet (VOP) network. The device can include a transceiver operable to transmit and receive session initiation protocol (SIP) communications over at least a portion of a VOP network. Also included can be a processor cooperatively operable with the transceiver. The processor can be configured to facilitate, responsive to receipt of an invite request, determining if the invite request is a diagnostic invite. If the invite request is a diagnostic invite, then the audible alerting of subscriber and display of caller-id can be suppressed. An automatic final or provisional response can be generated to establish two-way media flow and the dialog without subscriber intervention. After two-way media flow is established, diagnostics can be launched on the device. Responsive to receipt of diagnostic information requests and after two-way media flow is established, the processor can respond with diagnostic information responses.

One or more embodiments also provide a computer-implemented method for remote diagnosis of a device in a voice over packet (VOP) network. The method provides for initiating a session with the device in accordance with session initiation protocol (SIP) communications, the session initiation including an invite request with both a diagnostic invite and a session initiation protocol (SIP) message body that specifies that diagnostics are to be launched, wherein the diagnostics are at the device, and an acknowledgement response to the invite request, to establish two-way media flow with the device. After two-way media flow is established, the method provides for transmitting, to the device, diagnostic information requests and receiving, from the device, diagnostic information responses.

Further, one or more embodiments can provide for a computer-readable medium having instructions for execution by a computer. The instructions can include a computer-implemented method for remote diagnosis of a device in a voice over packet (VOP) network. The instructions can implement a diagnostics module including instructions for performing diagnosis actions in response to diagnostic information requests, and responding to the diagnostic information requests with diagnostic information responses. The instructions further can provide for exchanging an invite request and an acknowledgement response to establish two-way media flow. Also the instruction can include, after the two-way media flow is established, launching the diagnostics; and responsive to receipt of diagnostic information requests and after two-way media flow is established, responding with diagnostic information responses.

The purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 illustrates a simplified and representative call flow diagram;

FIG. 2 illustrates a second simplified and representative call flow diagram;

FIG. 3 is a block diagram illustrating a message format;

FIG. 4 is a block diagram illustrating portions of a device to be diagnosed;

FIG. 5 is a block diagram illustrating portions of a device controlling remote diagnosis;

FIG. 6 is a flow chart illustrating a procedure for conducting a remote diagnosis of a device in a VOP (voice over packet) network; and

FIG. 7 is a flow chart illustrating a procedure for a diagnostic session.

### DETAILED DESCRIPTION

In overview, the present disclosure concerns communication networks, often referred to as voice over packet (VOP) networks, or more particular VoIP (voice over internet protocol) networks, such as may be associated with networks supporting voice and/or multi-media communication between wireless and/or wire line devices. Such communication networks may provide additional services such as data communications, signal, and/or video services. Such networks can include network infrastructure devices which transfer the communications between wireless and/or wire line devices, for example customer premise/provided equipment (CPE). More particularly, various inventive concepts and principles are embodied in systems, devices, and methods therein for providing remote diagnosis of devices in a VOP network.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to enable remote management, support, troubleshooting and diagnosis of VOP devices. Troubleshooting problems with the device can be done remotely, for example from customer-care centers, during non-peak hours or even during active calls, in a non-intrusive manner.

Further in accordance with exemplary embodiments, there is provided a session initiation protocol (SIP) call flow and diagnostic session call flow which can take advantage of quality assurance capabilities available in a device, for example in a PIQUA-enabled device available from Texas Instruments. The call flows and capabilities can be built into a customer care application (such as a softphone or an IP phone) and on the device to be diagnosed. Thus, in many scenarios a customer's complaint promptly can be addressed, resulting in a happy and growing subscriber base. The call flows can utilize existing formats in the standard SIP protocol.

SIP is based on an HTTP (hyper text transfer protocol)-like request/response transaction mode. Each transaction includes a request that invokes a particular method, or function, on a server and at least one response. The endpoints, called user agents (UAs), establish a session by sending an invite (INVITE) request, which contains a number of header fields that indicate the actions that requester wants the server/receiver to take. RFC 2976, the SIP INFO Method, (and evolutions and variants thereof) defines information (INFO) messages and protocols for the purpose of communicating mid-session signaling messages along the signaling path for the call.

Further described herein is use of INFO messages to enhance and enable the standard SIP UA with diagnostic capabilities after the call/dialog has been established, for example by a session initiation, more particularly with a standard format INVITE. Also described are the message body and message headers used to carry the mid-session diagnostic messages.

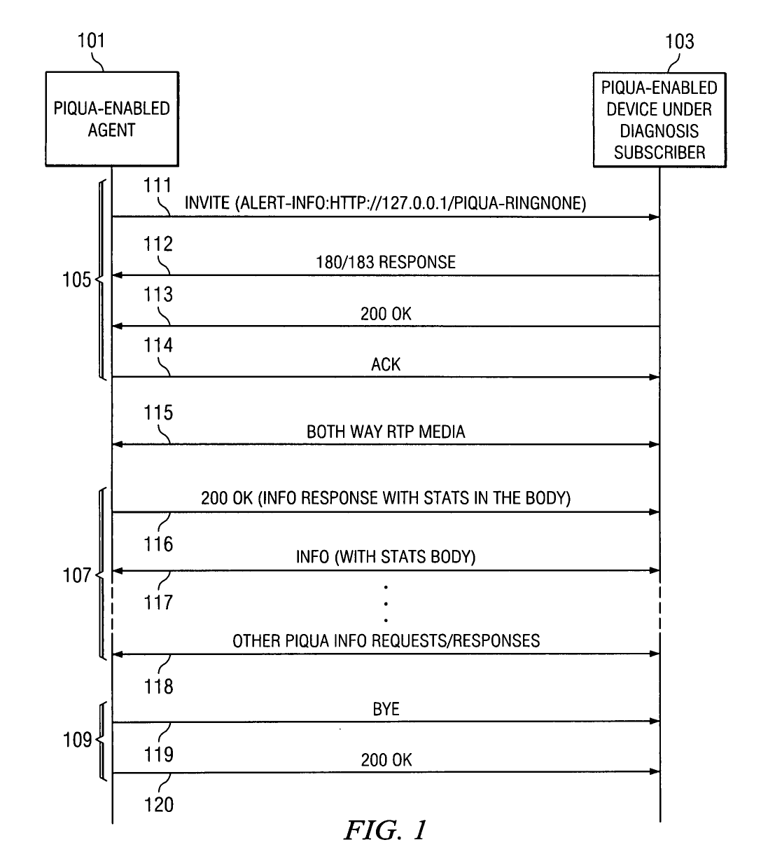

Referring now to FIG. 1, a simplified and representative call flow diagram will be discussed and described. The illustrated call flow is between a PIQUA-enabled agent corresponding to the device controlling diagnosis 101 and a PIQUA-enabled subscriber 103 corresponding to the device undergoing diagnosis. The call flow includes a session initiation sequence 105, a diagnostic sequence 107, and a session termination sequence 109.

The session initiation sequence 105 is used to establish a dialog between a UAC (user agent client) and a UAS (user agent server), in this illustration the PIQUA-enabled subscriber 103 and the PIQUA-enabled agent 101, respectively. The session initiation sequence 105 can proceed according to standard SIP protocols. Accordingly, the session initiation sequence 105 can include an INVITE 111 from the UAC to the UAS, a 180/183 response 112 from the UAS to the UAC, a 200 OK 113 from the UAS to the UAC, and an acknowledgement ACK 114 from the UAC to the UAS.

In this example, the Alert-Info header is utilized, as defined in RFC 3261 and evolutions and variants thereof. The Alert-Info header has a unique value, for example a unique URL value in accordance with RFC 3261, more particularly a value of “<http://127.0.0.1/PIQUA-RINGNONE>” (referred to as PIQUA-RINGNONE) (unique diagnostic value). Upon receiving the Alert-Info header with the unique diagnostic value, the device under diagnosis can disable audible alerting and suppress display of caller-id (CLIP), so that the remote diagnosis can be non-intrusive. This INVITE is referred to sometimes as a diagnostic INVITE request or more particularly a PIQUA INVITE, and the session which is established can be referred to as a diagnostic session or a PIQUA session.

The 200 OK response (also referred to as a final response) from the UAS automatically enables a two-way RTP (real time packet) media flow 115. Optionally, known techniques can be utilized such as PRACK/UPDATE to modify the session establishment if desired.

The diagnostic sequence 107 can commence once the session is established. The diagnostic sequence 107 can include an INFO request with a message having a diagnosis action, here statistics 116 (INFO statistics request); the 200 OK INFO response message with a body having detailed statistics 117 (INFO statistics response); and other INFO requests and responses 118 with diagnosis actions or responses (generally, diagnostic INFO requests and diagnostic INFO responses, and collectively diagnostic INFO messages).

In the diagnostic sequence 107, the UAC (here, the PIQUA-enabled agent 101) sends a diagnostic INFO request (more particularly, a PIQUA INFO request) to the UAS (here, the PIQUA-enabled subscriber 103). The UAS sends a response and can respond with one or more diagnostic INFO messages (more particularly, a PIQUA INFO message). The diagnostic INFO request indicates the diagnosis action, such as the illustrated INFO statistics request 116. The INFO statistics request 116 can include an indication of the time interval for responding with statistics, and the number of repetitions. An example INFO statistics request is INFO (S:rxtxstat; interval=5000; count=−1), resulting in the device being diagnosed sending a INFO statistics response 117 with a statistics body and an INFO request with statistics body every 5000 ms until terminated.

Diagnostic INFO messages (requests and/or responses) 118 with other diagnosis actions also can be utilized in the diagnostic sequence 107. Diagnosis actions can include, by way of example, change connection mode, audit/change configuration, handle DBG (debug) commands, exchange media parameters, and the like. For INFO requests with diagnostic message bodies, the responses can be generated by the PIQUA-enabled agent 101 or the PIQUA-enabled subscriber 103. The diagnostic INFO messages which are in a particular diagnostic dialog (encompassing one or more diagnostic sequences) used can be determined by a diagnostic program, for example a technical support application or similar.

A standard session termination sequence can be utilized, for example to terminate the diagnostic session. The session termination sequence 109 utilizes a standard BYE 119 request from the UAC to the UAS, and a standard 200 OK request 120 from the UAC to the UAS. Other conventional packet flows can be utilized to terminate the session.

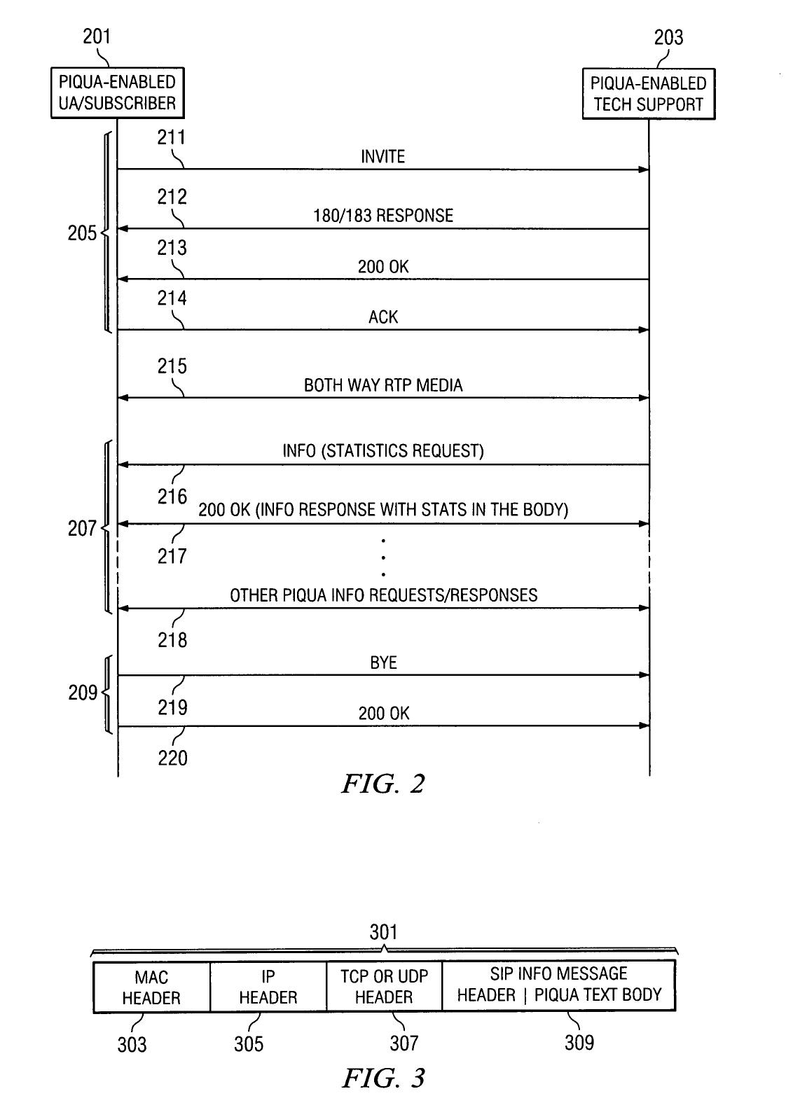

Referring now to FIG. 2, a second simplified and representative call flow diagram will be discussed and described. In this illustration, the call flow is between a PIQUA-enabled UA/subscriber 201, which is the device that will be diagnosed, and a device conducting a remote diagnosis, such as a PIQUA-enabled technical support 203. The call flow includes a session initiation sequence 205, a diagnostic sequence 207, and a session termination sequence 209. Here, the session is initiated by the PIQUA-enabled UA/subscriber 201.

The session initiation sequence 205 is used to establish a dialog between a UAC (user agent client) and a UAS (user agent server), in this illustration the technical support 203 and the subscriber 201, respectively. The session initiation sequence 205 can proceed according to standard SIP protocols, and can include an INVITE 211 from the UAC to the UAS, a 180/183 response 212 from the UAS to the UAC, a 200 OK 213 from the UAS to the UAC, and an acknowledgement ACK 214 from the UAC to the UAS.

It is not necessary to use a diagnostic INVITE request in this case as the call is originated by the subscriber and answered by a PIQUA enabled UAS. The 200 OK response 213 enables a two-way media flow 215.

Diagnostics, such as a diagnostic module or more particularly a diagnostic agent, can be launched at the device being diagnosed upon a session initiation sequence with diagnostic INVITE request, or upon generating or receiving a diagnostic INFO message. The diagnostic sequence 207 can commence once the session is established or diagnostics is launched. If the diagnostic INVITE request is not used, the diagnostic sequence 207 can be initiated by an INFO diagnostic request 216. The diagnostic sequence 207 can include diagnostic INFO messages such as a statistics request 216, one or more statistics responses 217, and other diagnostic INFO requests/responses 218, as previously described.

The session termination sequence 209 can utilize a standard BYE 219 request from the UAC to the UAS, and a standard 200 OK request 220 from the UAC to the UAS.

If the PIQUA-enabled subscriber and the PIQUA-enabled agent for conducting the diagnosis are already connected, the session initiation 205 can be omitted. This might occur, for example, if a user contacts technical support via the user's CPE. The PIQUA-enabled subscriber can initiate the diagnostic session 207 (as illustrated in FIG. 2), or the PIQUA-enabled agent can initiate the diagnostic session. Furthermore, in some situations it might not be necessary or desirable to have the caller id and audible alerts suppressed. If there is already an established dialog between the device to be diagnosed and the device performing the remote diagnosis, then the diagnostic INVITE request will be treated in accordance with standard conventions as a call-waiting call; there would be no audible alerts and the user on the device being diagnosed will not be aware of the additional call leg.

If a user seizes the line during a diagnostic dialog, optionally mid-call signaling information can be provided. For example, the diagnostic dialog can move to the background, and/or the diagnostic dialog can be canceled or suspended to be resumed later.

The diagnostic INVITE request can be omitted if preferred, and a conventional session initiation can be substituted. The called party (for example, an automated interactive voice response (IVR) system or a customer care agent) could then conduct a remote diagnosis by using the diagnostic session 207 during the established dialog. For example, statistics could be monitored and/or tests triggered using a diagnostic session following a conventional session initiation and potentially other intervening conventional SIP messages.

It will be appreciated that additional packet flows between various routers or other network infrastructure device have been omitted from the illustrated call flows to avoid obscuring the discussion, but will be understood by those versed in VOP techniques.

Referring now to FIG. 3, a block diagram illustrating message format will be discussed and described. The call flows can be conducted over a VOP network, according to SIP (session initiation protocol), and thus can have a standard SIP message format. Accordingly, the diagnostic INFO messages in the diagnostic session can be in the form of SIP INFO messages. A packet 301 communicating a SIP INFO message 309 can include a MAC (media access control) header 303, an IP (Internet protocol) header 305, a TCP (transmission control protocol) (or similar) header 307, and the SIP INFO message 309. The MAC header 303, IP header 305, and other header (e.g., TCP header or UDP header) 307 are well understood and will not be discussed further.

The SIP INFO message 309 includes a header and a text body. RFC 2976 generally defines INFO methods which can be used to communicate signaling information during a dialog. The purpose of the INFO message is to carry mid-session messages between SIP user agents. To accommodate diagnostic messages, the standard INFO message 309 header and body format can be utilized. More particularly, the body format can be a text body format.

The present description proposes the following media type registration/definition for use in connection with the SIP INFO message header:

Media type name: application

Media subtype name: piqua

Required parameters: none

Optional parameters: version

Encoding scheme: text

In accordance with the above SIP INFO message header, an example content-type header in an INFO message can appear as follows:

Content-Type: application/piqua; version=1.0

Content-Transfer-Encoding: text

Various diagnosis actions can be included in the body of the INFO message. By way of example, the diagnosis actions can include connection mode, statistics request, configuration audit, debug command, and/or media parameters, similar other diagnostic procedures, and the like. Text message bodies and actions for each of these are discussed in more detail below.

A receiver of a connection mode message can place the device into connection mode. An example connection mode is C:<connection-mode>. The connection modes can be, for example, network-loopback, encoder-loopback, decoder-loopback, tid-loopback, pcmtrace-loopback, replcate, conference, sendonly, recvonly, inactive, and/or sendrecv. The connection modes conference and replcate can be successful if there is an existing call leg on the active port (to conference or replicate) and such diagnostic INFO messages arrive in an established diagnostic session.

A receiver of an INFO statistics request can respond with specific statistics in a statistics INFO message of its own, where the SIP message body contains the statistics, for example in text format. The INFO statistics request can take optional parameters such as interval and count, so that the device being diagnosed is instructed to send a SIP INFO message with a message body containing the statistics, for example at an indicated periodical interval, more particularly, at the expiry of an interval for a count number of times. Statistics so generated can be turned off, for example by sending “S:none”. An example INFO statistics request is S:<stats-request>; <interval=3000|count=10>. INFO statistics requests can include, for example, rxtx, vp, err, sec, rtcp, rtcpxr, vq, vad, call, fax, dim, misc, plr, ec, and/or none.

A configuration audit can be requested for various subsystems or modules. An example INFO configuration audit request is A:<sub-system to be audited for configuration>. A response to an INFO configuration audit request can include the sub-system configuration, which can be sent in an INFO response message by a receiving UAS.

An example INFO debug command is D:<dbgcmd>. This can make the command-line or shell available via signaling protocol and can overcome the NAT/FW issues that typically prevent remote access to a device using standard protocols such as Telnet or SSH (secure shell).

An example INFO media parameter command is M:<media-params>. The value can be MGCP (media gateway control protocol) style “a:” line in the CRCX (create connection) enabling selection of TX (transmit) coding parameters.

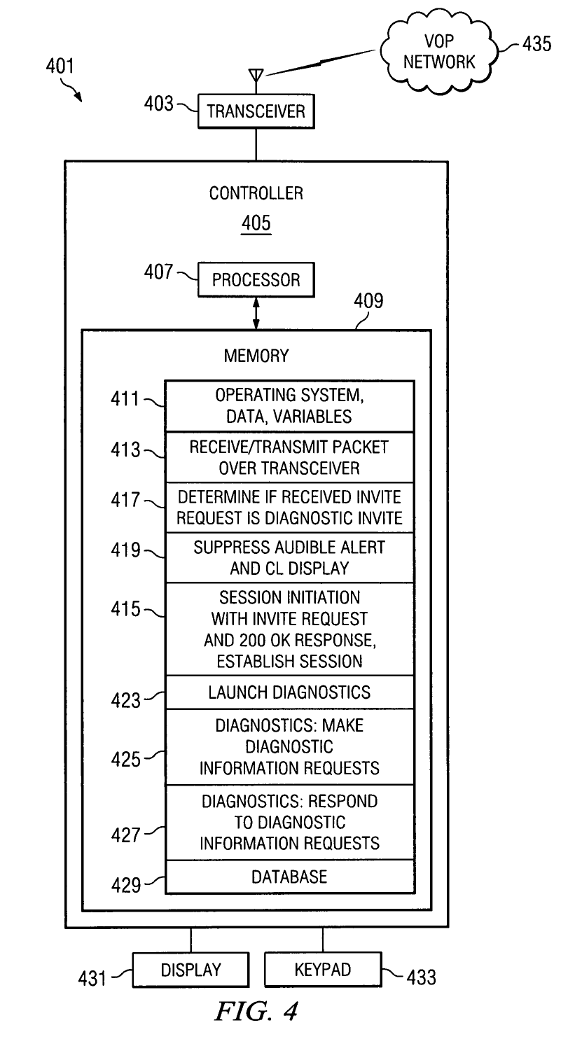

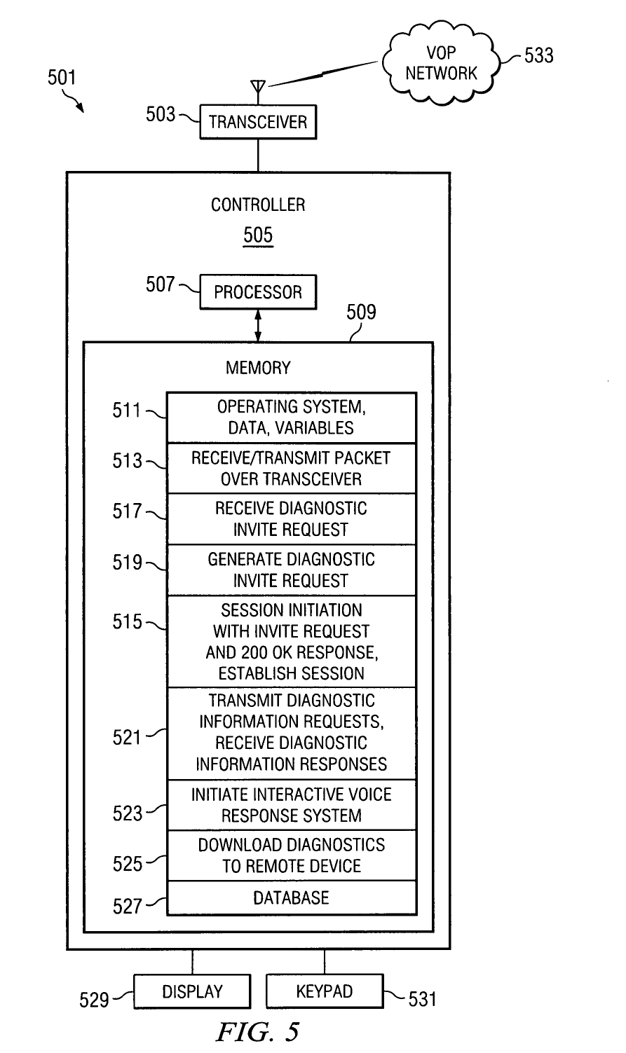

Examples of a device to be diagnosed and a device conducting the diagnosis are discussed in connection with FIG. 4 and FIG. 5, respectively. FIG. 4 illustrates relevant portions of the device to be diagnosed, whereas FIG. 5 illustrates relevant portions of the device conducting the diagnosis.

Referring now to FIG. 4, a block diagram illustrating portions of an exemplary device to be diagnosed will be discussed and described. The device 401 may be equipped with a receiver and transmitter or other communication port, represented here by transceiver 403, which can communicate with a VOP network 435. The device 401 can include one or more controllers 405. The controller 405 may include a processor 407, a memory 409, and other optional components, which will be well understood to those in this field. Advantageously, the controller 405 can be provided in a system-on-a-chip architecture.

The device 401 can communicate with a communication network. The communication network can be a packet switching network such as the illustrated voice over packet (VOP) network 435, or more particularly a voice over IP (VoIP) network.

The processor 407 may be, for example, one or more microprocessors and/or one or more digital signal processors. The memory 409 may be coupled to the processor 407 and may comprise a read-only memory (ROM), a random-access memory (RAM), a read/write flash memory, a programmable ROM (PROM), and/or an electrically erasable read-only memory (EEPROM).

The memory 409 may include multiple memory locations for storing, among other things, an operating system, data and variables 411 for programs executed by the processor 407; computer programs for causing the processor to operate in connection with various functions such as receiving/transmitting 413 packet over transceiver, session initiation 415 with INVITE request and 200 OK response to establish session, determining 417 if received INVITE request is a diagnostic INVITE, suppressing 419 audible alerts and caller id (CL) display, launching 423 diagnostics, diagnostics: making 425 diagnostic INFO requests, and diagnostics: responding 427 to diagnostic INFO resquests; and a database 429 of various information used by the processor 407. The computer programs may be stored, for example, in ROM or PROM and may direct the processor 407 in controlling the operation of the device 401. Each of these computer programs is discussed by way of example below.

The processor 407 may be programmed for receiving/transmitting 413 packets over the transceiver 403. Responsive to signaling from the transceiver 403, packets can be received and/or transmitted in accordance with known techniques. Although a wireless communication connection is illustrated, a wireline connector can be provided, and the transceiver 403 can be included in a communication port such as a USB port, Ethernet port, or other serial port, or the like.

The processor 407 may be programmed for session initiation 415, such as with an INVITE request and 200 OK response, to establish two-way media flow and the dialog. The session initiation can be particular to remote diagnosis, or can be a conventional session initiation, as described above.

The processor 407 may be programmed to determine 417 if a received INVITE request is a diagnostic INVITE request. For example, the received INVITE request can be checked to determine whether it contains an Alert-Info header with a specific value indicating remote diagnosis. More particularly, the Alert-Info header in the INVITE request can be checked to determine if it includes a predetermined PIQUA-RINGNONE indication, for example, an http: address of 127.0.0.1/PIQUA-RINGNONE. If the INVITE is a diagnostic INVITE, then the processor 407 may take various actions as described herein.

The processor 407 may be programmed to suppress 419 audible alerts and/or caller id display. In particular, if a diagnostic INVITE request is received, then audible alerts and called id display that would otherwise be generated by the device 401 can be suppressed in accordance with known techniques. Thereafter, the processor 407 can conduct remote diagnosis in a non-intrusive manner. This can be used, for example, where the remote diagnosis is initiated during periods of low usage or without an express request from a subscriber. Also, if the remote diagnosis is conducted while the user is on another call leg, the audible alerts and caller id display can be suppressed to avoid intruding on the user.

The processor 407 may be programmed to launch 423 diagnostics. Advantageously, the diagnostics can be programmed as an agent, for example a SIP agent. As is typical for SIP agents, the diagnostics 423 can include a client (UAC) to make diagnostic requests, and a server (UAS) to respond to received diagnostic requests and to provide diagnostic responses. In the illustrated example, the diagnostics which are launched include a client to make 425 diagnostic INFO requests, and a server to respond 427 to diagnostic INFO requests (collectively a diagnostic system agent).

The diagnostics of the processor 407 may be programmed to make 425 diagnostic INFO requests. For example, a user may desire to call into an automated technical support. The processor 407 can be programmed to generate a diagnostic INFO request to send to a device which can direct the remote diagnosis.

The diagnostics of the processor 407 may be programmed to respond 427 to diagnostic INFO requests, if a diagnostic INFO request is received. As described above, the message body can include a diagnosis action. The processor 407 can be programmed to interface with a diagnostic system agent, for example a PIQUA agent where the device 401 is a PIQUA-enabled device, to perform the diagnostic requested in the message body of the diagnostic INFO request. The processor 407 can obtain diagnostic data returned by the diagnostic system agent, for example, insert the diagnostic data into a SIP INFO message body, and transmit the message as a SIP INFO response. The diagnostic responses can be sent as one or more INFO requests and can be repeated periodically if so directed by the diagnostic INFO request.

It should be understood that various logical groupings of functions are described herein. Different realizations may omit one or more of these logical groupings. Likewise, in various realizations, functions may be grouped differently, combined, or augmented. Furthermore, variations can omit functions, such as suppressing 419 audible alert and/or CLIP display. Similarly, the present description may describe or suggest a database or collection of data and information. One or more embodiments can provide that the database or collection of data and information can be distributed, combined, or augmented, or provided locally (as illustrated) and/or remotely (not illustrated).

The user may invoke functions accessible through the keypad 433 or other user input device, such as a computer mouse, a touchpad, a touch screen, a trackball, and/or a keyboard. The processor 407 may direct information such as an audible tone to audible device (such as a speaker) (not illustrated) and/or a caller id to a display 431. The display 431 may include, for example, a conventional liquid crystal display (LCD) or other visual display.

Referring now to FIG. 5, a block diagram illustrating portions of an exemplary device 501 controlling remote diagnosis will be discussed and described. The device 501 for controlling remote diagnosis may include a receiver and transmitter or other communication port, as represented here by the transceiver 503, to communicate over the VOP network 533. The device 501 can include one or more controllers 505, and each controller 505 may include a processor 507, a memory 509, and other components which are well known.

The processor 507 may be, for example, one or more microprocessors and/or one or more digital signal processors. The memory 509 may be coupled to the processor 507 and may comprise a ROM, a RAM, a read/write flash memory, a PROM, and/or an EEPROM. The memory 509 can have memory locations for storing, among other things, an operating system, data and variables 511 for programs executed by the processor 507; computer programs for causing the processor to control remote diagnosis including functions such as receiving/transmitting 513 a packet, session initiation 515 with INVITE request and 200 OK response to establish a session, receiving 517 diagnostic INVITE request, transmitting 521 diagnostic INFO requests and receiving diagnostic INFO responses, initiating 523 interactive voice response (IVR) system, and downloading 525 diagnostics to a remote device; and a database 527 of various information used by the processor 507. The computer programs may be stored, for example, in ROM or PROM and may direct the processor 507 in controlling the operation of the device 501. These computer programs are discussed by way of example below.

The processor 507 may be programmed for receiving/transmitting 513 packets over the transceiver 503, similar to the description given in connection with FIG. 4.

The processor 507 may be programmed for session initiation 515, including an INVITE request and a 200 OK response, to establish for example a two-way media flow and the dialog. The session initiation can begin when the processor 507 receives 517 a diagnostic INVITE request. The session initiation can be particular to initiate diagnosis, or can be a conventional session initiation, as described above.

The processor 507 may be programmed for receiving 517 a diagnostic INVITE request. Optionally, the device needing remote diagnosis can initiate a session, for example beginning with a diagnostic INVITE request. More typically, the device controlling the remote diagnosis can initiate a diagnostic session with the device to be diagnosed.

The processor 507 may be programmed for transmitting 521 diagnostic INFO requests and receiving diagnostic INFO responses, once a two-way media flow is established with the device to be diagnosed. The diagnostic requests and responses have been discussed in detail.

Optionally, the processor 507 can include a customer support or technical support agent, such as an interactive voice response (IVR) system, to direct the sequence, type and content of diagnostic INFO requests and responses. The processor 507 may be programmed for initiating 523 the technical support, for example, the IVR system.

Optionally, the processor 507 can be programmed for downloading 525 the diagnostics which are to be launched to a remote device. For example, it might be desirable to download an updated diagnostic system agent, or more particularly a PIQUA agent The download can be handled in accordance with known techniques.

Optionally, a user may interact with the device through the optional keyboard 531 or other user input device. Optionally, the processor 507 may direct information to a display 529.

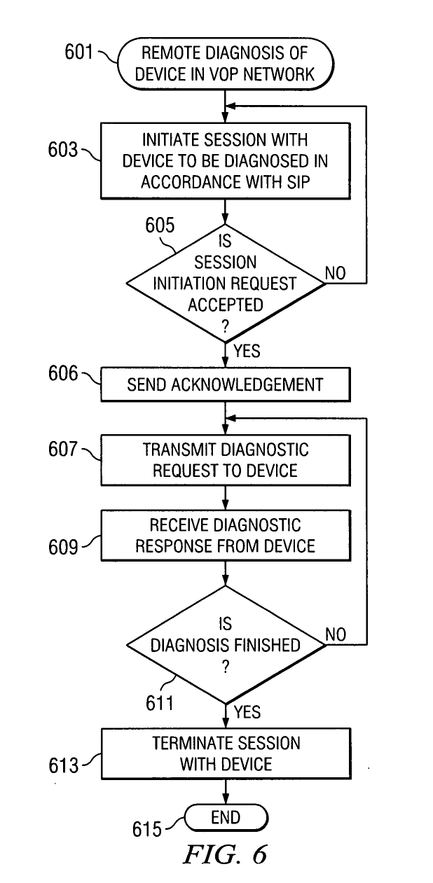

Referring now to FIG. 6, a flow chart illustrating an exemplary procedure 601 for conducting a remote diagnosis of a device in a VOP (voice over packet) network will be discussed and described. The procedure can advantageously be implemented on the device controlling the remote diagnosis, for example, a processor of a controller, described in connection with FIG. 5 or other apparatus appropriately arranged. The procedure 601 includes initiating 603 a session with the device to be diagnosed. The session can initiated in accordance with SIP session initiation procedures, for example including an INVITE request and ultimately a 200 OK. If the session is not initiated, that is, if 605 the session initiation request is not accepted, the procedure 601 can repeat the attempt to initiate 603 the session with the device to be diagnosed.

Once the session initiation request is accepted, the procedure 601 can send 606 an acknowledgement to the device, transmit 607 a diagnostic INFO request to the device, and receive 609 a diagnostic INFO response from the device. If 611 the diagnostic dialog is not finished, the transmission 607 of the diagnostic INFO request and receipt 609 of the diagnostic INFO response can be repeated. Additional diagnostic INFO messages can be exchanged.

When the diagnostic dialog is finished 611, the procedure 601 optionally can terminate 613 the session with the device, as described above.

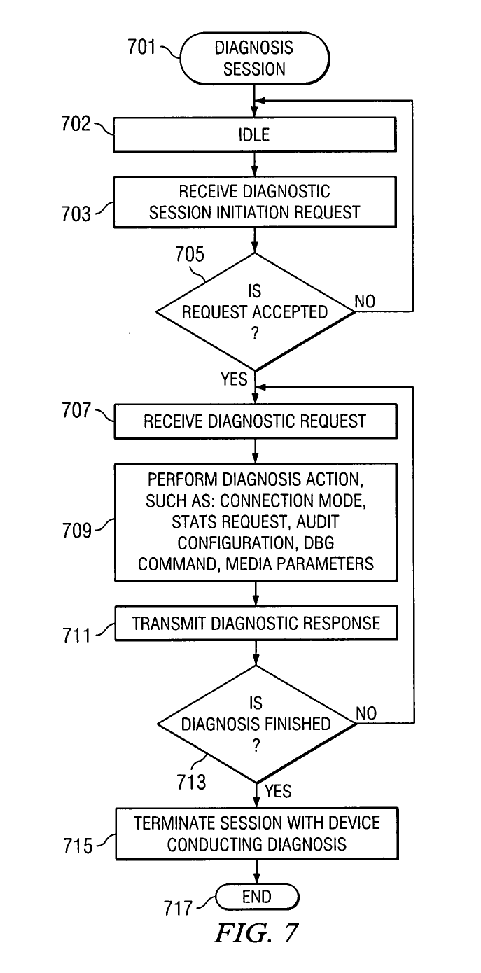

Referring now to FIG. 7, a flow chart illustrating an exemplary procedure 701 for a diagnostic session will be discussed and described. The procedure can advantageously be implemented on the device to be diagnosed, for example, a processor of a controller, described in connection with FIG. 4 or other apparatus appropriately arranged.

Typically, the procedure can wait in an idle 702 state. The procedure 701 can include receiving 703 a diagnostic session initiation request. The session can be initiated in accordance with SIP session initiation procedures, for example, including an INVITE (optionally a diagnostic INVITE) request and ultimately a 200 OK. If the session is not initiated, that is, if 705 the request is not accepted, the process can wait in idle 702.

Once the request is accepted, the procedure 701 can receive 707 a diagnostic INFO request. The diagnosis action in the SIP message body can be performed 709. Previously described exemplary diagnosis actions include connection mode, stats request, audit configuration, debug command, and/or media parameters. Having performed the diagnosis action, the procedure 701 can transmit 711 one or more diagnostic INFO responses. If 713 remote diagnosis is not finished, such as by a termination command or a session termination sequence, the receipt 707 of the diagnostic request, performance 709 of the diagnosis action, and transmission 711 of the diagnostic response can be repeated.

When the diagnostic dialog is finished 713, the procedure 701 can terminate 715 the session, as described above.

The foregoing discussion sometimes refers particularly to PIQUA-enabled technology. PIQUA is an example of diagnostics, also referred to as a diagnostics module or a diagnostic system agent, which is a software module for invoking diagnostic tools and collecting measurements and statistics. Information gathered by the diagnostic system agent can be provided to clients that are either internal or external to the PIQUA-enabled device. Tools that can be invoked by the diagnostic system agent can include, for example, packet traces, bit error rate calculations, diagnostic loop backs, call and error statistics, echo cancellation modes, time stamps, and/or action-oriented triggers, and the like.

The PIQUA message bodies used with INFO requests optionally can also be used with other methods such as DSP/BIOS options features (available from Texas Instruments, allowing diagnostics to be performed without establishing a dialog first. Also, a method can be defined to carry out diagnostics, such as PIQUA.

It should be noted that the references herein to a device to be remotely diagnosed may be used interchangeably to refer to a customer premise/purchased equipment (CPE), a subscriber unit, a wireless subscriber device or the like. Each of these terms denotes a device sometimes associated with a user or subscriber, including a wireless mobile device or wired device that may be used with a public network, for example in accordance with a service agreement, or within a private network such as an enterprise network. Examples of such units include devices variously referred to as personal digital assistants, personal assignment pads, personal computers, SIP phones with multi-media communication capabilities, VoIP phones, video phones, cellular handsets, cellular phones, IP Phones, processors with softphone software, SIP devices, hardware endpoints, or equivalents thereof provided such units are constructed to communicate over a VOP network. The device to be remotely diagnosed optionally can integrate one or more other functions such as WLAN (wireless local area network), LAN (local area network) switch, NAT/FW (network address translation/firewall); and optionally can interface to an ISP (Internet service provider) access technologies, QOS (quality of service), home wiring, and the like.

Furthermore, the references herein to a device for conducting a remote diagnosis can be used to refer to various network devices providing or communicating on VOP networks, such as servers, general purpose computers, personal computers, routers, edge routers, switches, bridges, brouters, gateways, media gateways, centralized media gateways, session border controllers, trunk gateways, media boxes, call servers, and the like, and variants or evolutions thereof.

Furthermore, the communication networks of interest include those that transmit information in packets, for example, those known as packet switching networks, more particularly using VOP (voice over packet) protocol, and even more particularly using VoIP (voice over IP) protocol, and even more particularly using SIP-formatted packets. Such networks can include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A device in a voice over packet (VOP) network, comprising:
a transceiver operable to transmit and receive session initiation protocol (SIP) communications over at least a portion of a VOP network; and
a processor cooperatively operable with the transceiver, and configured to facilitate,
responsive to receipt of an invite request, determining if the invite request is a diagnostic invite, and if the invite request is a diagnostic invite, then
suppressing audible alert and display of caller id,
generating a final response to establish two-way media flow, after two-way media flow is established, launching diagnostics on the device, and
responsive to receipt of diagnostic information requests and after a diagnostic session is established, responding with diagnostic information responses.

2. The device of claim 1,
wherein the invite request can be received during an established two-way dialog,
wherein the audible alert and caller id display which is suppressed is associated with the diagnostic session, whereby the diagnostic session is transparent to a user using the established two-way dialog.

3. The device of claim 1,
wherein the diagnostic invite request can be received during an established two-way dialog,
wherein the audible alert and called id display which is suppressed is associated with the diagnostic session,
wherein the diagnostic session is handled in accordance with call-waiting call procedures.

4. The device of claim 1, wherein the diagnostics is configured to facilitate
performing diagnosis actions in response to diagnostic information requests received over the transceiver, and
responding to the diagnostic information requests with diagnostic information responses.

5. The device of claim 1, wherein the device is a CPE (customer premise equipment).

6. The device of claim 1, wherein the invite request is determined to be a diagnostic invite if the value PIQUA-RINGNONE is used in the alert-info header.

7. The device of claim 6, wherein the value PIQUA-RINGNONE determines the diagnostics to be launched.

8. A computer-implemented method for remote diagnosis of a device in a voice over packet (VOP) network, comprising:
initiating a session with the device in accordance with session initiation protocol (SIP) communications, the session initiation including
an invite request with both a diagnostic invite and a session initiation protocol (SIP) message body that specifies that diagnostics are to be launched, wherein the diagnostics are at the device, and
an acknowledgement response to the invite request, to establish a dialog and a two-way media flow with the device; and
after the dialog is established, transmitting, to the device, diagnostic information requests and receiving, from the device, diagnostic information requests and responses.

9. The method of claim 8, wherein the diagnostic invite request can be transmitted during an established two-way dialog.

10. The method of claim 8,
wherein the diagnostic invite request is transmitted during an established two-way dialog, and
wherein the two-way media flow is handled in accordance with call-waiting call procedures.

11. The method of claim 8, wherein
in a first mode, the diagnostic invite request can be transmitted from the device and the responses can be received at the device, and
in a second mode, the diagnostic invite request can be transmitted to the device and the responses can be received from the device.

12. The method of claim 8, further comprising downloading the diagnostics to the device.

13. A computer-readable medium comprising instructions for execution by a computer, the instructions including a computer-implemented method for remote diagnosis of a device in a voice over packet (VOP) network, the instructions for implementing:
a diagnostics module including instructions for
performing diagnosis actions in response to diagnostic information requests, and
responding to the diagnostic information requests with diagnostic information responses;
exchanging an invite request, a final response, and an acknowledgement to establish a dialog and a two-way media flow;
after the dialog is established, launching the diagnostics; and
responsive to receipt of diagnostic information requests and after two-way media flow is established, responding with diagnostic information responses.

14. The computer-readable medium of claim 13,
wherein the invite request is a diagnostic invite request,
wherein the exchanging includes generating the diagnostic invite request and receiving the responses and generating the acknowledgement.

15. The computer-readable medium of claim 13,
wherein the exchanging includes receiving the invite request and generating the final response,
further comprising determining if the invite request is a diagnostic invite, and if the invite request is a diagnostic invite, then
suppressing audible alert and display of caller id.

16. The computer-readable medium of claim 15,
wherein the invite request can be received during an established two-way dialog,
wherein the audible alert and display which is suppressed is associated with the two-way media flow, whereby the two-way media flow is transparent to a user using the established two-way dialog.

17. The computer-readable medium of claim 15,
wherein the invite request can be received during an established two-way dialog,
wherein the audible alert and display which is suppressed is associated with the two-way media flow,
wherein the two-way media flow is handled in accordance with call-waiting call procedures.

18. The computer-readable medium of claim 15, wherein the invite request is determined to be a diagnostic invite if the value PIQUA-RINGNONE is used in the alert-info header.

19. The computer-readable of claim 15, wherein the value PIQUA-RINGNONE determines the diagnostics to be launched.

20. The computer-readable medium of claim 13, wherein the device is a CPE (customer premise equipment).
